(19) United States
(12) Patent Application Publication
(10) Pub. No.: US 2012/0042260 A1
(43) Pub. Date: Feb. 16, 2012

(54) BACKDOOR ADOPTION PROCESS AND TOOL

(75) Inventor: Matan Michael Kohen, Thornhill (CA)

(73) Assignee: GANZ, Woodbridge (CA)

(21) Appl. No.: 13/210,604

(22) Filed: Aug. 16, 2011

Related U.S. Application Data
(60) Provisional application No. 61/374,035, filed on Aug. 16, 2010.

(51) Int. Cl. G06F 3/01

(52) U.S. Cl. 715/739

(57) ABSTRACT

A customer service tool which is used to locally adopt a virtual item in a virtual world.

### BACKGROUND OF THE INVENTION

Virtual pet websites are known that allow a user to virtually adopt a pet by going through an online adoption process. Once such website is described in U.S. Pat. No. 7,677,948 to Ganz, which is hereby incorporated by reference in its entirety.

### BRIEF SUMMARY OF THE INVENTION

An aspect of the present invention relates to a tool to be used by customer service representatives for creating an account and registering a pet without going through the usual multimedia-based adoption process, which may be tedious, time-consuming and/or involve multiple steps. This tool allows a customer service representative, to troubleshoot and solve customer problems in an efficient manner.

According to an example embodiment, all of the account creation and pet adoption information is entered into a single-page web form and the entire process is completed in a single step when the customer service rep clicks “adopt”. In response, the system generates the user account, completes the pet adoption, and provides all of the resulting data on a single confirmation page.

### BRIEF DESCRIPTION OF THE DRAWINGS

In the drawings:

FIG. 1 shows a block diagram of the different computers used according to the present system;

FIG. 2 shows a screenshot of the adoption tool;

FIG. 3 shows a screen shot of the adoption tool with all of the different features filled then;

FIG. 4 shows a “prompt” showing that one of the virtual world is unavailable for adoption; and

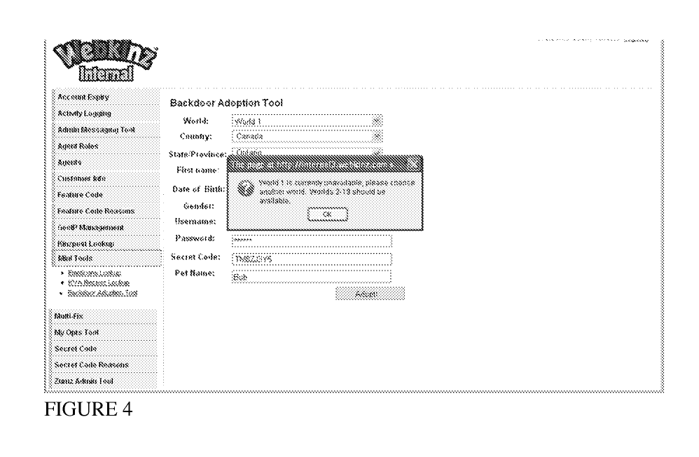

FIG. 5 shows the customer information screen which is displayed when a successful adoption has been carried out.

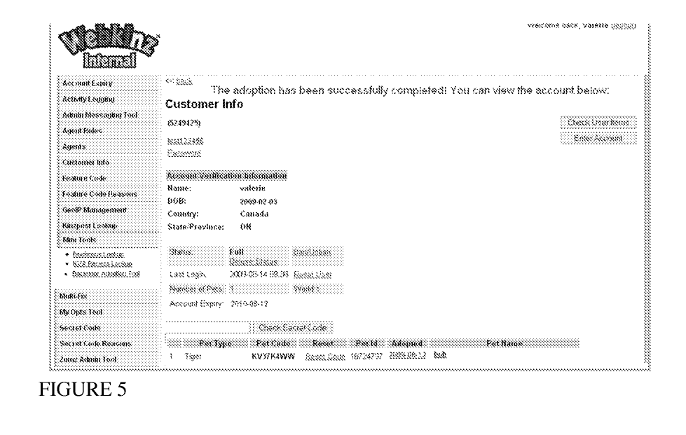

### DETAILED DESCRIPTION

The website that is operated by the assignee of the present invention is described in U.S. Pat. No. 7,677,948 to Ganz, which is hereby incorporated by reference in its entirety that website operates on a server computer to serve content to a number of different client computers.

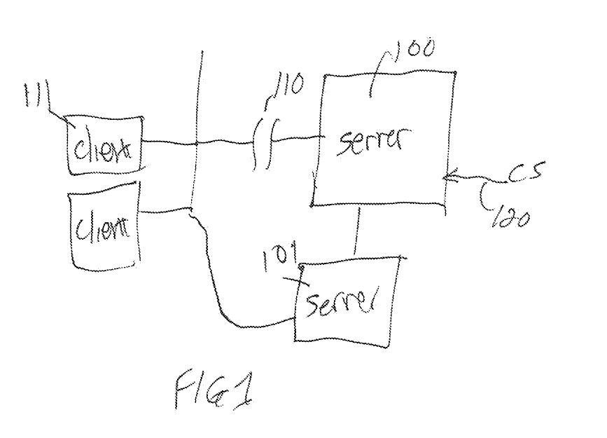

The basic operation of the system uses the architecture shown in FIG. 1, where the server computer 100 includes a number of different functions therein, typically executed as software on the server computer. The server computer is connected via the Internet 110 to a number of clients such as 111.

Various administrators of the website need to communicate with the program that runs on the server. According to one embodiment, the customer service representative uses a tool that enables an adoption of a virtual pet to be completed without going through the live site in which the pet is adopted over the Internet.

This backdoor adoption tool enables a customer service representative to enter all of the requested information and also pick a virtual world and the server 100, or another associated server 101 that the account will be on.

This tool will be used for bypassing the lengthy adoption process in order to duplicate issues on the site more efficiently. For example, this may enable customer service representatives to assist users in registering their new virtual items, for example when the users calling on the phone.

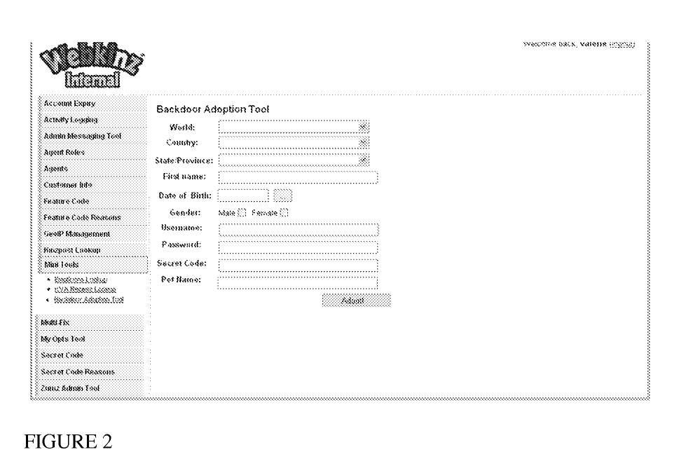

This will operate on the computer, using the processor, memory, and user interface of the computer. A screenshot of the backdoor adoption tool user interface is shown in FIG. 2.

The first field is a drop down list that CS can choose a world from. This drop down list should be updated automatically with any release of a new world. For example, there may be a number of different choices for the world such as “Ganz World”, “Webkinz World”, and others.

The following information will be asked in a drop down form:
World
Country
State/province

The following information will be asked in free form fields:
First name
Username
Password
Secret code
Pet name

Date of birth will have a date button that will automatically populate the field with the chosen birth date when selected.

Gender will have 2 radio buttons; one for male and female accordingly.

Tool Functionality: Selecting a World

To pick a world, Customer Service selects a world from the drop down list. It must be noted that although all worlds are available in the list, they may not be available for adoption at that particular time (too full, down, etc).

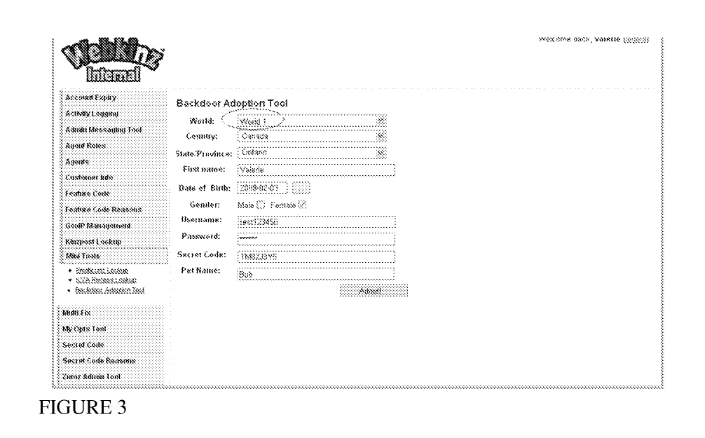

An exemplary filled in screenshot is shown in FIG. 3. In this exemplary scenario, the customer service representative has selected World 1 and entered the rest of the required information. However, in this example, World 1 is currently unavailable. In this case, the tool provides a prompt that alerts the customer service representative to choose another world. It should also show the available worlds in case there is more than one unavailable world. When all worlds are available it will reflect so in the message as well.

All fields must be filled out in order for the adoption to go through. If they are not, a prompt should highlight in red underneath the field; letting CS know to fill out the required field.

If a specific selected user code has already been used, then the user may receive a message or prompt to show the customer service representative that they need to enter another username otherwise the adoption will not go through.

If the secret code is not correct or has been used, a prompt will come up informing the customer service representative that they need to re-enter a valid code in order to complete the adoption process.

When all fields have been filled out and an available world has been selected, the adoption will be successfully completed after the customer service representative selects the “adopt” key. This causes the customer service representative to be redirected to the customer info page in order to view account information and enter the account: (please note the prompt at the top of the page, it will be needed to let Customer Service know the adoption has been completed successfully)

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example the above has described adopting virtual item using the code, but other forms of virtual adoptions can be carried out. The virtual adoptions can be a virtual pets or of any other virtual item.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, displayport, or any other form.

When operated on a computer, the computer may be a server computer that sends information to multiple different client computers, or can be a client computer that interacts with a server computer, or can be a stand-alone computer operating based on stored instructions. The computer can include a processor that operates to accept user commands, execute instructions and produce output based on those instructions. The processor is preferably connected to a communication bus. The communication bus may include a data channel for facilitating information transfer between storage and other peripheral components of the computer system. The communication bus further may provide a set of signals used for communication with the processor, including a data bus, address bus, and/or control bus.

The communication bus may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or any old or new standard promulgated by the Institute of Electrical and Electronics Engineers (“IEEE”) including IEEE 488 general-purpose interface bus (“GPIB”), and the like.

A computer system used according to the present application preferably includes a main memory and may also include a secondary memory. The main memory provides storage of instructions and data for programs executing on the processor. The main memory is typically semiconductor-based memory su.ch as dynamic random access memory (“DRAM”) and/or static random access memory (“SRAM”). The secondary memory may optionally include a hard disk drive and/or a solid state memory and/or removable storage drive for example an external hard drive, thumb drive, a digital versatile disc (“DVD”) drive, etc.

At least one possible storage medium is preferably a non-transitory computer readable medium, such as a hard drive, solid state drive, DVD or other memory of any form having stored thereon computer executable code (i.e., software) and/or data thereon in a non-transitory form. The computer software or data stored on the removable storage medium is read into the computer system as electrical communication signals.

The computer system may also include a communication interface. The communication interface allows' software and data to be transferred between computer system and external devices (e.g. printers), networks, or information sources. For example, computer software or executable code may be transferred to the computer to allow the computer to carry out the functions and operations described herein. The computer system can be a network-connected server with a communication interface. The communication interface may be a wired network card, or a Wireless, e.g., Wifi network card.

Software and data transferred via the communication interface are generally in the form of electrical communication signals.

Computer executable code (i.e., computer programs or software) are stored in the memory and/or received via communication interface and executed as received. The code can be compiled code or interpreted code or website code, or any other kind of code.

A “computer readable medium” can be any media used to provide computer executable code (e.g., software and computer programs and website pages), e.g., hard drive, USB drive or other. The software, when executed by the processor, preferably causes the processor to perform the inventive features and functions previously described herein.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer readable media can be an article comprising a machine-readable non-transitory tangible medium embodying information indicative of instructions that when performed by one or more machines result in computer implemented operations comprising the actions described throughout this specification.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A server computer, comprising:
a processor, memory, and a user interface which accept inputs that allow operating to adopt a virtual item on a website, where the inputs are accepted in a first mode over an Internet connection, and the inputs are accepted in a second mode over a local connection whereby a customer service representative can locally cause a virtual item to be adopted, using entry of customer information, a code that represents information about the virtual item, and one of a plurality of different virtual worlds in which the virtual item is adopted, wherein the processor operates to verify said code and said customer information, and also to verify the virtual world, and to automatically adopt the item and in the item to a user's account in the virtual world, based on said information which is locally received from the customer service representative.

2. A computer as in claim 1, wherein said virtual item is a virtual pet.

3. A computer as in claim 1, wherein said inputs accepted in a first mode are accepted over the internet.

4. A computer as in claim 1, wherein
said customer information includes username information indicative of the customer account.

5. A computer as in claim 1, wherein said processor checks the virtual world to determine if the virtual world is accepting new registrations.
